(19) United States
(12) Patent Application Publication
(10) Pub. No.: US 2011/0222188 A1
(43) Pub. Date: Sep. 15, 2011

(54) PERPENDICULAR RECORDING MAGNETIC HEAD, MANUFACTURING METHOD THEREOF AND MAGNETIC DISK DRIVE

(75) Inventors: Kimitoshi Etoh, Odawara (JP); Masayoshi Ishibashi, Tokyo (JP); Katsuro Watanabe, Hitachiohta (JP); Junichi Hashimoto, Chigasaki (JP)

(73) Assignee: Hitachi, Ltd.

(21) Appl. No.: 13/020,679

(22) Filed: Feb. 3, 2011

(30) Foreign Application Priority Data
Mar. 15, 2010 (JP) 2010-057401

(51) Int. Cl. G11B 5/11; H04R 31/00

(52) U.S. Cl. 360/123.12; 29/603.18; G9B/5.037

(57) ABSTRACT

The reduction in a recording magnetic field due to the narrowing of recording track width along with the improved surface recording density is prevented and the increasing of accuracy in the track width is achieved, enabling an improvement in recording performance. In a perpendicular magnetic recording head, a main pole 13 includes a first main pole portion 131 having an inverse trapezoidal shape with a bevel angle and a second main pole portion 132 laminated on the first main pole portion. The second main pole portion 132 has no bevel angle, is generally rectangular and defines track width. The second main pole portion has a tapered shape extending from the predetermined position of a flare portion toward an air bearing surface.

### CLAIM OF PRIORITY

The present application claims priority from Japanese application serial No. 2010-57401, filed on Mar. 15, 2009, the content of which is hereby incorporated by reference into this application.

### BACKGROUND OF THE INVENTION

1. Field of the Invention

The present invention relates generally to a perpendicular recording magnetic head, a manufacturing method thereof and a magnetic disk drive using the magnetic head. In particular, the invention relates to narrowing of write track width by a perpendicular recording magnetic head and increasing of accuracy in the narrowed track width.

2. Description of the Related Art

An improvement in the surface recording density of a perpendicular recording magnetic head is required along with the recording density growth of magnetic disk drives. To meet the requirement, it is important to reduce write track width. However, the reduced write track width causes a reduction in the magnetic field generated from the tip of a main pole to a magnetic recording medium.

A magnetic disk drive performs read and write operations over a wide range from the inner circumference to outer circumference of a magnetic recording medium. In this case, a magnetic head performs read and write operations at a skew angle of approximately 0 to 15° relative to a tangential line in the rotating direction of the magnetic recording medium in the inner circumference and outer circumference. At that time, if a main pole has a rectangular air bearing surface, there arises a problem of erasing adjacent tracks.

To solve this problem, a main pole having the so-called inverse trapezoidal shape is put into practical use to deal with narrowed track width. In this shape, the track width on the leading side of the main pole is narrower than that on the trailing side thereof. To improve surface recording density, it is necessary to narrow the track width while the track portion of the main pole defining the write track width is kept in an inverse trapezoidal shape dealing with a skew angle. As described above, to improve surface recording density, it is essential to narrow track width, inevitably leading to a reduction in recording field.

A technology for improving field intensity by increasing the area of the air bearing surface of a main pole while dealing with a skew angle (JP-A-2008-243350 and JP-A-2003-242607) and a technology for concentrating field intensity on the tip portion (the air bearing surface) of a main pole (JP-A-2009-4068) are disclosed as the countermeasures against the reduction in recording magnetic field. However, to further improve high surface recording density, further narrowed track is required. In addition, increasing of accuracy in track width is also a major problem. Along with this, an improvement in recording magnetic field is required under the existing conditions.

In order to improve the surface recording density of a perpendicular recording magnetic head, it is important to precisely narrow write track width while the shape of the air bearing surface of a main pole track portion is kept in an inverse-trapezoidal shape dealing with a skew angle. To make this possible, the thickness of the main pole is reduced according to the track width. In contrast, the thinning of the main pole poses a major problem of deterioration in recording performance such as a reduction in field intensity or degradation in field gradient.

### SUMMARY OF THE INVENTION

Accordingly, it is an object of the present invention to prevent the reduction in a recording magnetic field along with the narrowing of write track width while dealing with a skew angle and to increase the accuracy in the narrowed track width.

According to an aspect of the present invention, there is provided a perpendicular recording magnetic head including: a main pole; an auxiliary pole; a coil generating a magnetic field; and a shield provided on each of a trailing side and cross track side of the main pole, wherein the main pole includes a first main pole portion having an inverse trapezoidal shape and a second main pole portion laminated on the first main pole portion, the second main pole portion defining a fixed track width and having a flare portion that is increased in width toward an element-height direction.

Preferably, in the perpendicular recording magnetic head, the second main pole portion has a rectangular air bearing surface and lateral width of the second main pole portion defines the track width.

Preferably, in the perpendicular recording magnetic head, the second main pole portion has a tapered shape extending from a predetermined position of the flare portion to a track tip of the air bearing surface.

Preferably, in the perpendicular recording magnetic head, the track tip portion having the tapered shape is formed within a thickness range of the second main pole portion.

Preferably, in the perpendicular recording magnetic head, saturation flux density (Bs) of the second main pole portion is equal to or greater than that of the first main pole portion.

Preferably, in the perpendicular recording magnetic head, the first main pole portion has a bevel angle but the second main pole portion has no bevel angle.

Preferably, in the perpendicular recording magnetic head, the second main pole portion has the length of width, in the track width direction, equal to the length of width in contact with the trailing side of the first main pole portion.

Preferably, in the perpendicular recording magnetic head, the saturation flux density (Bs) of at least one of the first main pole portion and the second main pole portion is increased toward a flare-height (Ly) zero direction.

Preferably, in the perpendicular recording magnetic head, material of the main pole is a magnetic plating film containing two or three elements of Co, Ni and Fe.

According to another aspect of the present invention, there is provided a magnetic disk drive provided with the perpendicular recording magnetic head configured as above.

According to another aspect of the present invention, there is provided a method of manufacturing a perpendicular recording magnetic head that includes a main pole, an auxiliary pole, a coil generating a magnetic field, and a shield provided on each of a trailing side and cross track side of the main pole, the main pole including a first main pole portion that has an inverse trapezoidal shape and a second main pole portion that is laminated on the first main pole portion, the second main pole portion defining a fixed track width and having a flare portion that is increased in width toward an element-height direction, the method comprising the steps of: forming an inorganic insulating film on a substrate; forming a hard mask for reactive ion etching (RIE) on the inorganic insulating film; forming a V-shaped trench by use of RIE with the hard mask used as a mask; forming a plating seed film on an inner surface of the V-shaped trench; and forming the first main pole portion and the second main pole portion through self-alignment in the V-shaped trench formed with the seed film, by magnetic plating.

The present invention produces the following effects:

(1) The main pole of the perpendicular recording magnetic head is formed of the first main pole portion having a bevel angle and formed in an inverse trapezoidal shape dealing with a skew angle, and the second main pole portion laminated on the first main pole portion, having no bevel angle and defining a fixed track width. Thus, a recording magnetic field can be increased.

(2) The track portion of the second main pole portion has a tapered shape in the element-height direction and the tapered tip portion of the air bearing surface is controlled within the range of the second main pole. Therefore, even if the taper angle slightly varies, the track width is constant. Thus, the accuracy in the track width can be increased.

(3) The perpendicular recording magnetic head is such that the main pole has the laminated structure of the first main pole portion and the second main pole portion. Therefore, even if the flare point is varied during the machining of the air bearing surface, the degree by which the area of the air bearing surface varies is smaller than that of the conventional art, i.e., the variation in effective track width can be reduced. Thus, superior recording performance can be provided.

(4) The second main pole portion is etched in a tapered shape from the predetermined position of the flare portion to the tip of the second main pole portion. Thus, the magnetic flux can be concentrated on the tip of the main pole, thereby increasing a recording magnetic field.

(5) According to the method of manufacturing a perpendicular recording magnetic head, the inorganic insulating film on the substrate is etched in a trench shape by RIE by use of the hard mask and the first main pole portion and the second main pole portion are subjected to continuous magnetic plating in the trench. Therefore, the first and second main pole portions can simultaneously be formed through self-alignment without individually forming the second main pole portion. Thus, the increasing of accuracy in the track width can be enabled, that is, the accuracy in the track width can be increased; therefore, yield can be improved.

### BRIEF DESCRIPTION OF THE DRAWINGS

FIG. 1A is a plan view of a general magnetic disk drive.

FIG. 1B is a cross-sectional view of the disk drive.

FIG. 2 illustrates the relationship between the configuration of a perpendicular recording magnetic head 7 and a magnetic disk 2.

FIG. 3 is a cross-sectional view of a perpendicular recording magnetic head according to an embodiment, in an element-height direction.

FIG. 4A illustrates the configuration of a main pole portion in the conventional art.

FIG. 4B illustrates the transition of track width of the main pole portion in the conventional art.

FIG. 5A illustrates a configuration of a main pole portion according to an embodiment.

FIG. 5B illustrates the transition of track width of the main pole portion according to the embodiment.

FIG. 6A illustrates a comparison between a conventional TWP structure and the main pole according to an embodiment of the present invention.

FIG. 6B illustrates a comparison in degree by which the area of the main pole increases between the conventional TWP structure and the main pole of the present invention if a flare length is varied.

FIG. 7 illustrates the relationship between the area ratio and the track width between the conventional TWP structure and the main pole of the present invention if the flare length is varied.

FIG. 8A illustrates manufacturing steps of the perpendicular recording magnetic head according to an embodiment.

FIG. 8B illustrates manufacturing steps of the perpendicular recording magnetic head according to the embodiment.

FIG. 8C illustrates manufacturing steps of the perpendicular recording magnetic head according to the embodiment.

FIG. 8D illustrates manufacturing steps of the perpendicular recording magnetic head according to the embodiment.

FIG. 8E illustrates manufacturing steps of the perpendicular recording magnetic head according to the embodiment.

FIG. 9 illustrates a perpendicular recording magnetic head according to another embodiment.

### DETAILED DESCRIPTION OF THE PREFERRED EMBODIMENTS

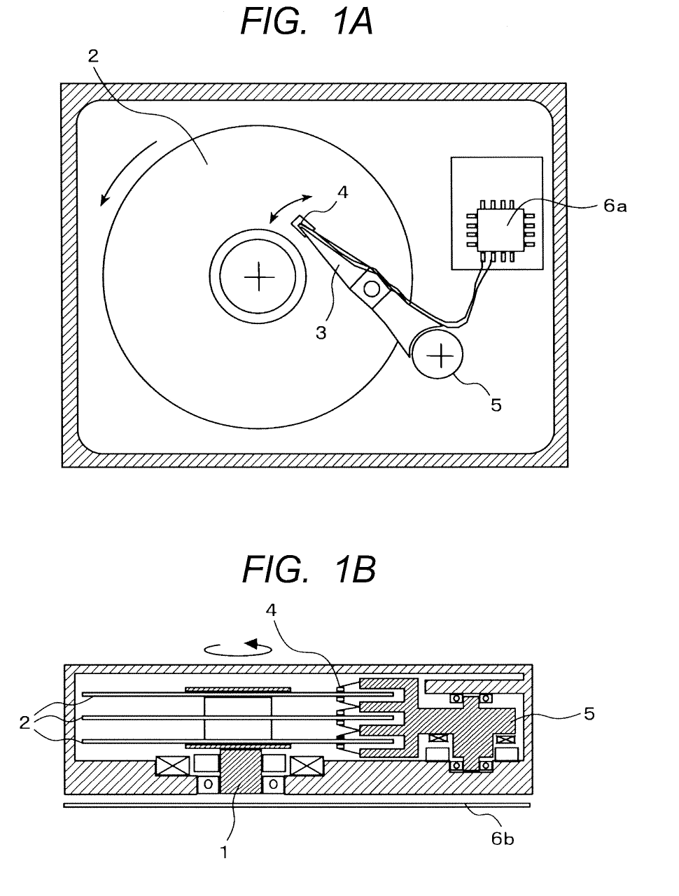

Preferred embodiments of the present invention will hereinafter be described with reference to the drawings. FIGS. 1A and 1B are a plan view and a cross-sectional view, respectively, illustrating a magnetic disk drive. The magnetic disk drive shifts a slider 4 secured to the tip of a suspension arm 3 to a targeted position on a magnetic disk (recording medium) to be rotated by a motor 1. In addition, a magnetic head (perpendicular recording magnetic head and read head) mounted on the slider 4 reads and/or writes a magnetized signal. The shifting and positioning of the magnetic head is done by driving a rotary actuator 5 to selectively control the magnetic disk radial directional-position (track) of the magnetic head. A signal written to and read from the magnetic head is processed by a signal processing circuit 6a and a circuit 6b mounted on a substrate.

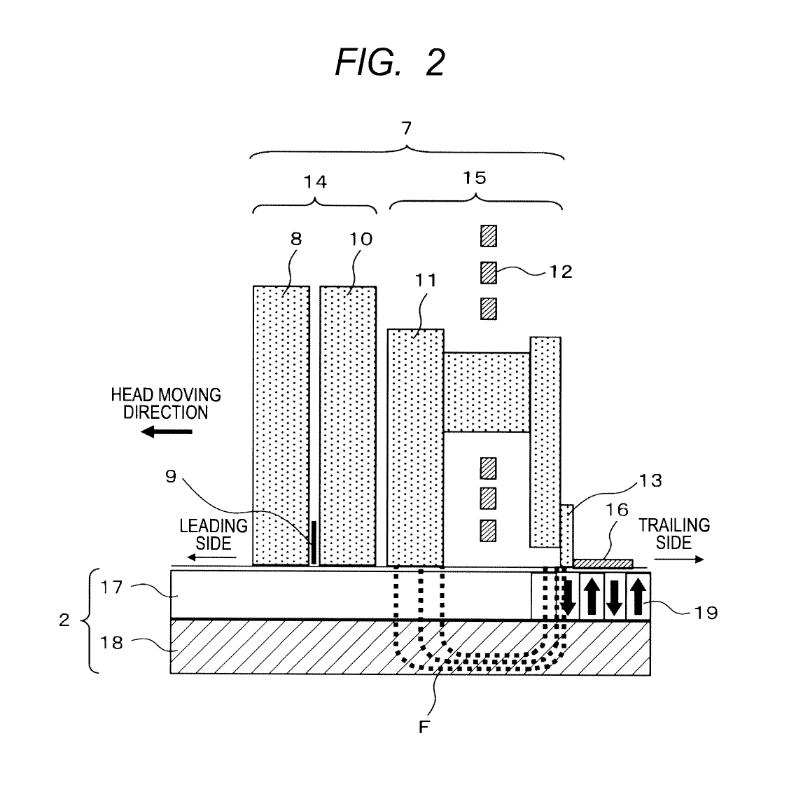

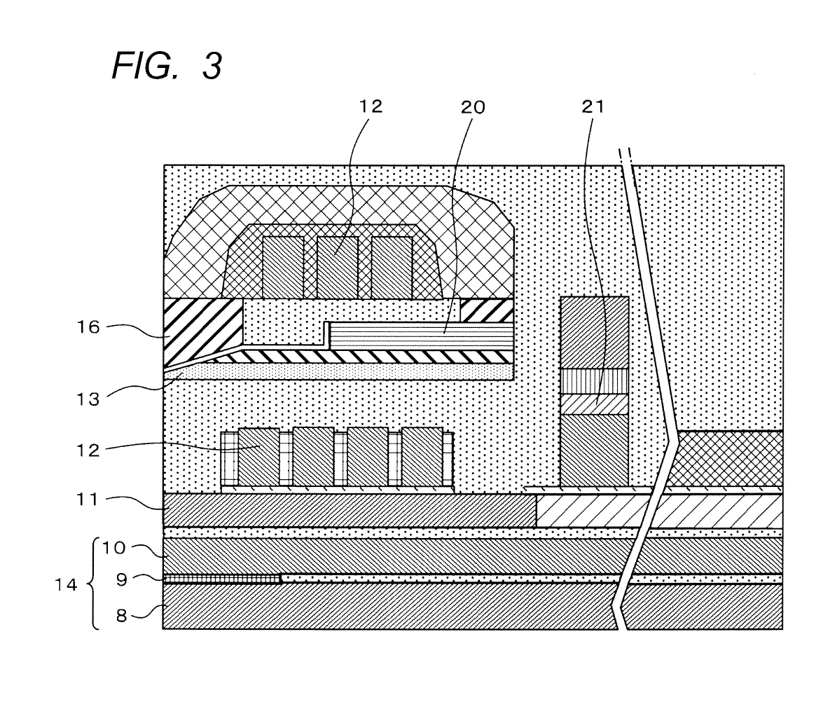

FIG. 2 illustrates the relationship between the configuration of a perpendicular recording magnetic head 7 and the magnetic disk 2.

The perpendicular recording magnetic head 7 includes a lower read shield 8, a read element 9, an upper read shield 10, an auxiliary pole 11, a thin film coil 12 generating a magnetic field, and a main pole 13 laminated in this order from the moving direction side (leading side) of the head. The lower read shield 8, the read element 9 and the upper read shield 10 constitute a read head 14. The auxiliary pole 11, the thin film coil 12 and the main pole 13 constitute a write head (single pole head) 15. The main pole 13 includes a track portion defining a write track width and a flare portion formed integrally with the track portion to gradually increase in width as it goes toward the element-height direction. A wrap-around shield 16 is formed on the trailing side of and on both track width-directional sides of the main pole 13. In view of the case where the magnetic head has a skew angle, the air bearing surface of the track portion of the main pole 13 is formed in an inverse-trapezoidal shape where the leading side width is narrow.

A magnetic flux F coming out of the main pole 13 of the write head 15 forms a magnetic circuit passing through a magnetic write layer 17 and soft underlayer 18 of the magnetic disk 2 and entering the auxiliary pole 11, to write a magnetized pattern 19 in the magnetic write layer 17. In this case, in relation to the rotational direction of the disk, the shape of a portion of the main pole 13 that lastly leaves from a point of the magnetic disk, i.e., the shape of the upper surface (the trailing side) and lateral surface of the track portion of the main pole has a large influence on the shape of the magnetized pattern. An intermediate layer may be formed between the magnetic write layer 17 and soft underlayer 18 of the magnetic disk 2 in some cases. Incidentally, the read element 9 of the read head 14 uses a giant magnetoresistive element (GMR), a tunneling magnetoresistive element (TMR) or the like.

FIG. 3 is a cross-sectional view of a perpendicular recording magnetic head according to one embodiment, in an element-height direction. The auxiliary pole 11 is connected to a yoke 20 via a back gap 21. The illustrated perpendicular recording magnetic head is an example of a helical coil configuration where the thin film coil 12 extends around the main pole 13 and the yoke 20. The present invention can be applied to the perpendicular magnetic recording head of a pan-cake configuration in which the thin film coil 12 extends around the back gap 21.

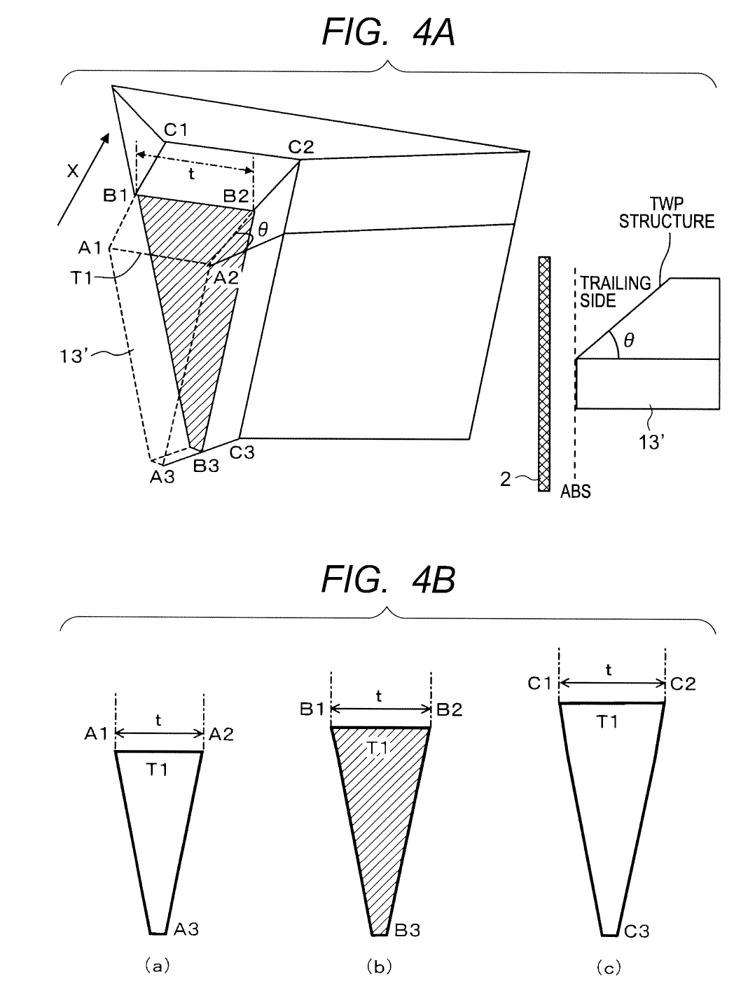

FIG. 4A illustrates the configuration of the main pole of a perpendicular magnetic recording head in the conventional art.

A main pole 13′ has a main magnetic configuration (TWP (tapered write pole): hereinafter, called the TWP structure) having a tapered shape on a trailing side. The TWP structure is shaped to have a taper angle (θ) of 20 to 30° on the trailing side with respect to the perpendicular of an air bearing surface (ABS) facing the recording medium 2.

The ABS is usually processed by being ground in the direction of arrow X. Therefore, the size of the ABS is variously varied depending on processing accuracy, i.e., a grinding position. Also the inverse-trapezoidal shape of the main pole 13′ is formed to have sizes as A1-A2-A3 (A-surface), B1-B2-B3 (B-surface) and C1-C2-C3 (C-surface). As illustrated in FIG. 4B-(a),-(b) and -(c), the C-surface is greater than the A-surface. Because of the TWP structure, one side (the long base of the inverse trapezoid) T1 of the ABS is also such that T1 of the C-surface is longer than T1 of the A-surface. This one side T1 defines track width t.

Variations in taper angle and processing accuracy in the ABS for determining a flare point in the conventional main pole 13′ cause a variation in the length of the one side of each of the A- to C-surfaces. This means that the processing accuracy varies the track width t and the thickness of the main pole 13′. For this reason, write performance degrades, reducing yields. The present invention solves this problem.

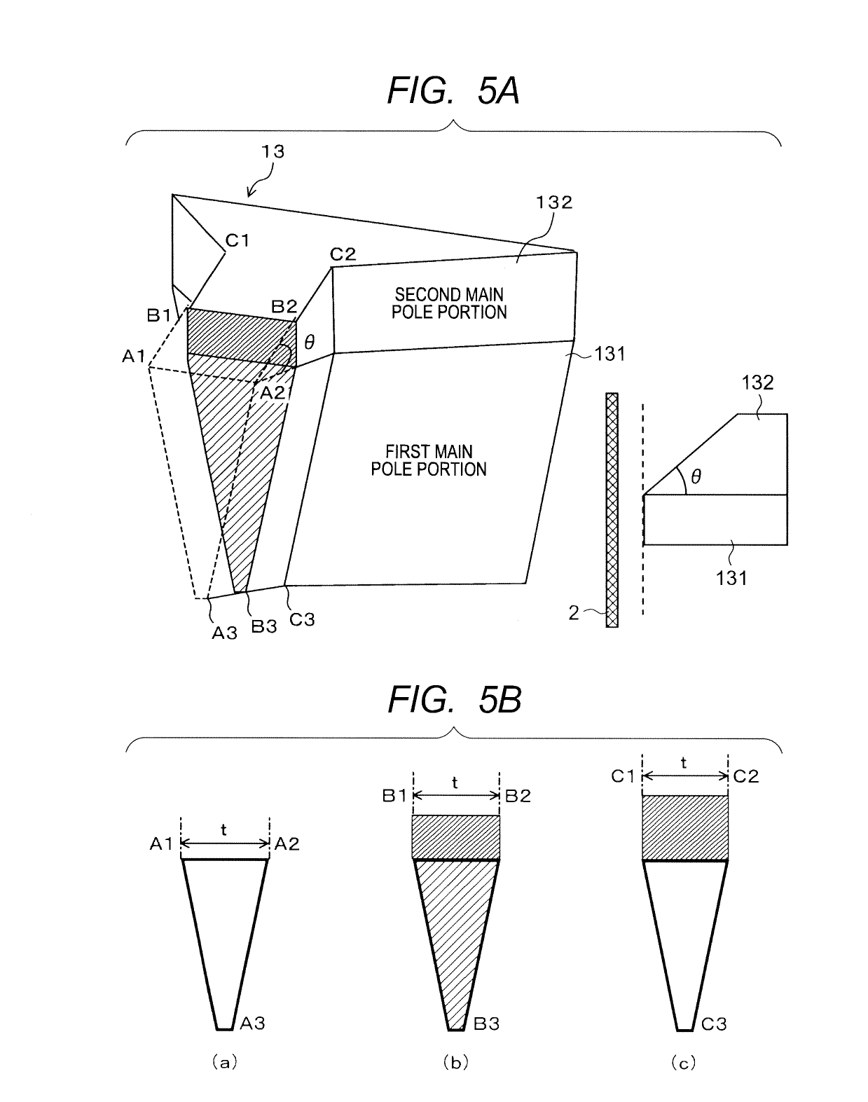

FIGS. 5A and 5B illustrate the configuration of the main pole of a perpendicular recording magnetic head according to an embodiment of the present invention. Referring to FIG. 5A, the main pole 13 includes a track portion defining a write track width and a flare portion formed integrally with the track portion to gradually increase in width as it goes toward the element-height direction. The main pole 13 includes a first main pole portion 131 with a bevel and a second main pole portion 132 without a bevel. The second main pole portion 132 is formed on the trailing side with a tapered shape having a taper angle of 20 to 30° and terminating at its tip portion. The head configuration having the so-called TWP structure is one feature of the present invention.

As illustrated in FIG. 5B-(a) and -(b), the track width is determined by the width of the second main pole portion 132 and is not affected by the variation in the taper angle of the TWP and in the air bearing surface processing. This produces an effect in that accuracy is constantly invariable.

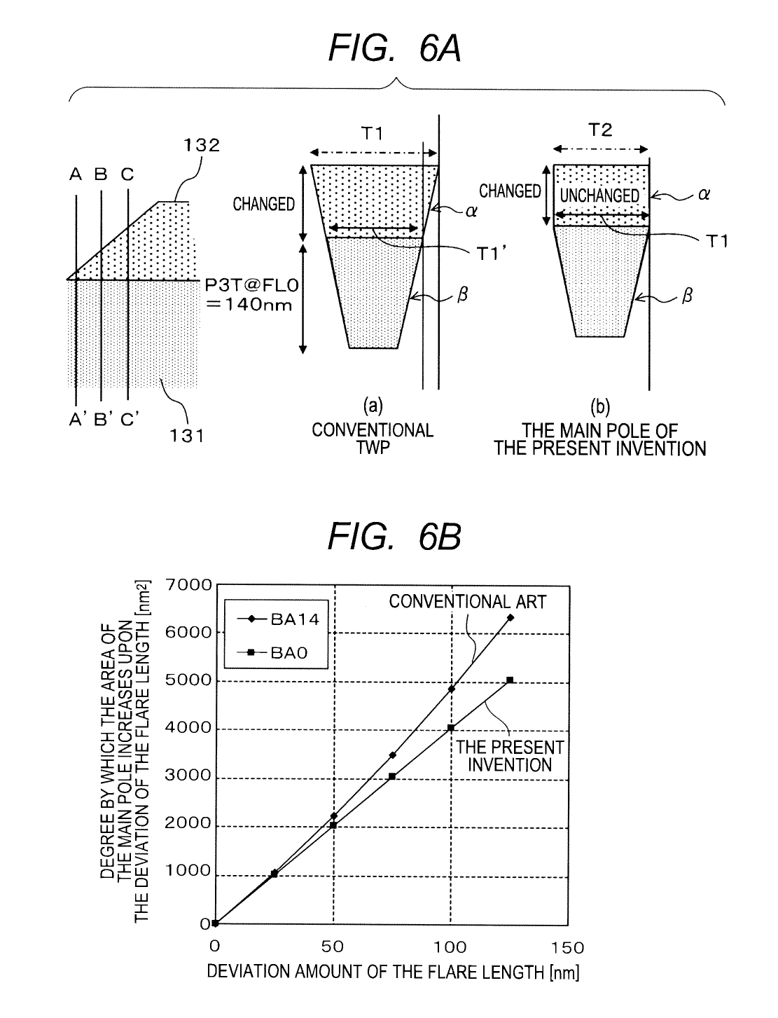

FIGS. 6A and 6B are views for assistance in explaining the feature of the present invention. FIG. 6A illustrates (a) the TWP structure of the conventional art and (b) the main pole of the present invention as viewed from the air bearing surface. The conventional main pole extends to a main pole thickness (P3T) at a bevel angle (β) of 14°. In short, BA (β=γ)=14°. Therefore, the track width is varied from T1′ to T1 by the grinding position of the main pole (T1′<T1).

In contrast, the main pole 13 of the present invention includes a first main pole portion having a bevel angle (β) of 14° and a second main pole portion having bevel angle (β) of 0° (i.e., having no bevel angle: BA=γ=0). Therefore, the second main pole portion has a uniform track width (T1=T2).

FIG. 6B illustrates a comparison in the degree by which the area of the main pole increases between the TWP structure of the conventional art and the main pole of the present invention in the case where a flare length is changed during the processing of the air bearing surface. If their inclinations in the figure are compared with each other, it is seen that the shape of the main pole of the present invention has smaller degree by which the area of the main pole increases than that of the conventional art. In other words, the small degree by which the area of the main pole increases means that a change in field intensity is small. This means that a change in effective track width (MCW) is small, which produces an effect of improving write performance.

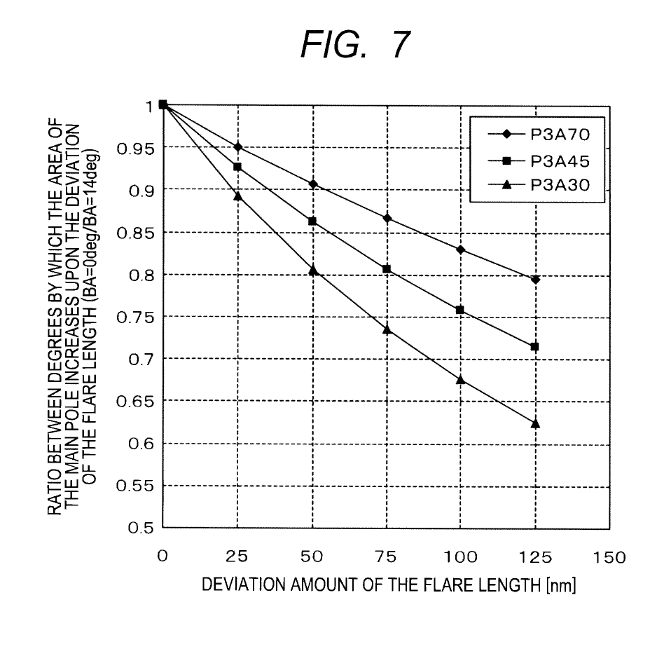

FIG. 7 illustrates the calculation results of track width dependency based on the comparison between the magnetic head configurations in FIG. 6A. In FIG. 7, the horizontal axis denotes a deviation amount of the flare length and the vertical axis denotes ratio between degrees by which the area of the main pole increases. FIG. 7 shows the tendency that the smaller the track width, the smaller the area ratio if the track width is changed to 30, 45 and 70 nm. Because of this, the narrower the track width is, the degree by which the area of the main pole increases becomes smaller than that of the conventional TWP structure (FIG. 6A-(a)). Thus, the configuration of the main pole of the present invention has an effect in that the variation in effective track width is reduced and the write performance is improved.

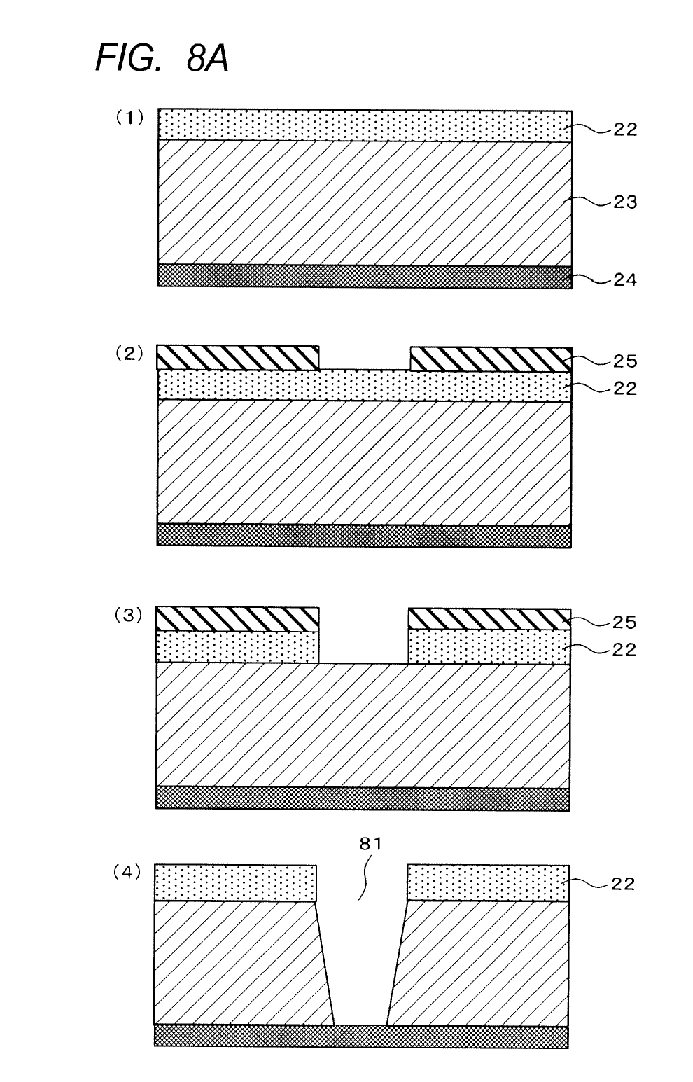

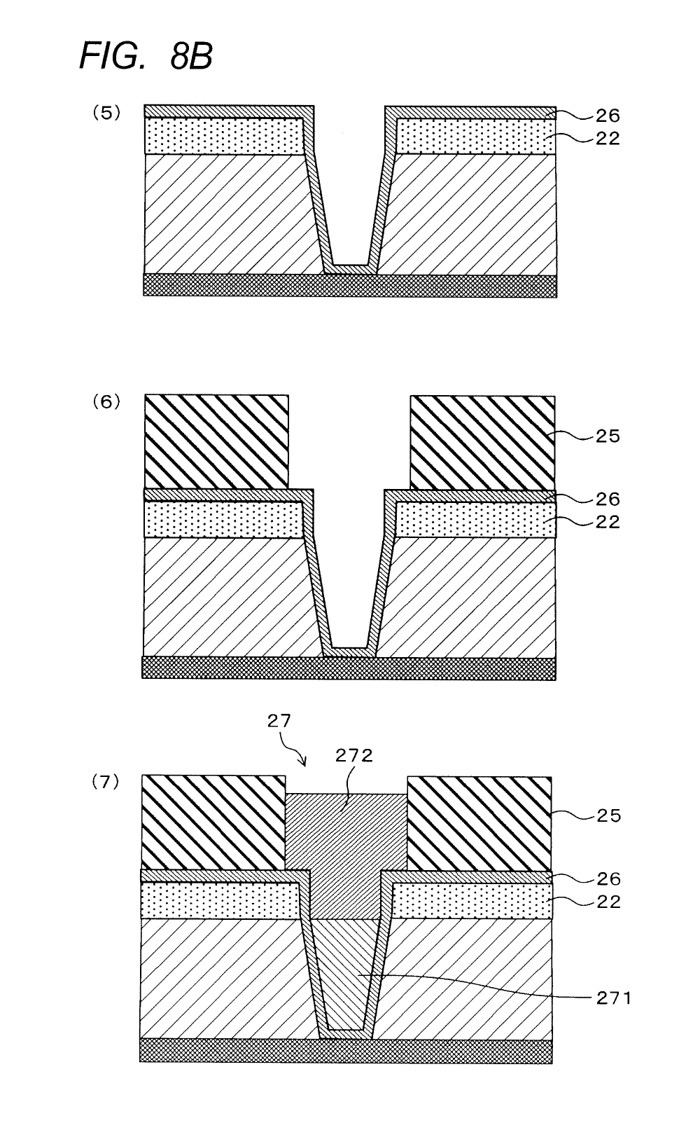

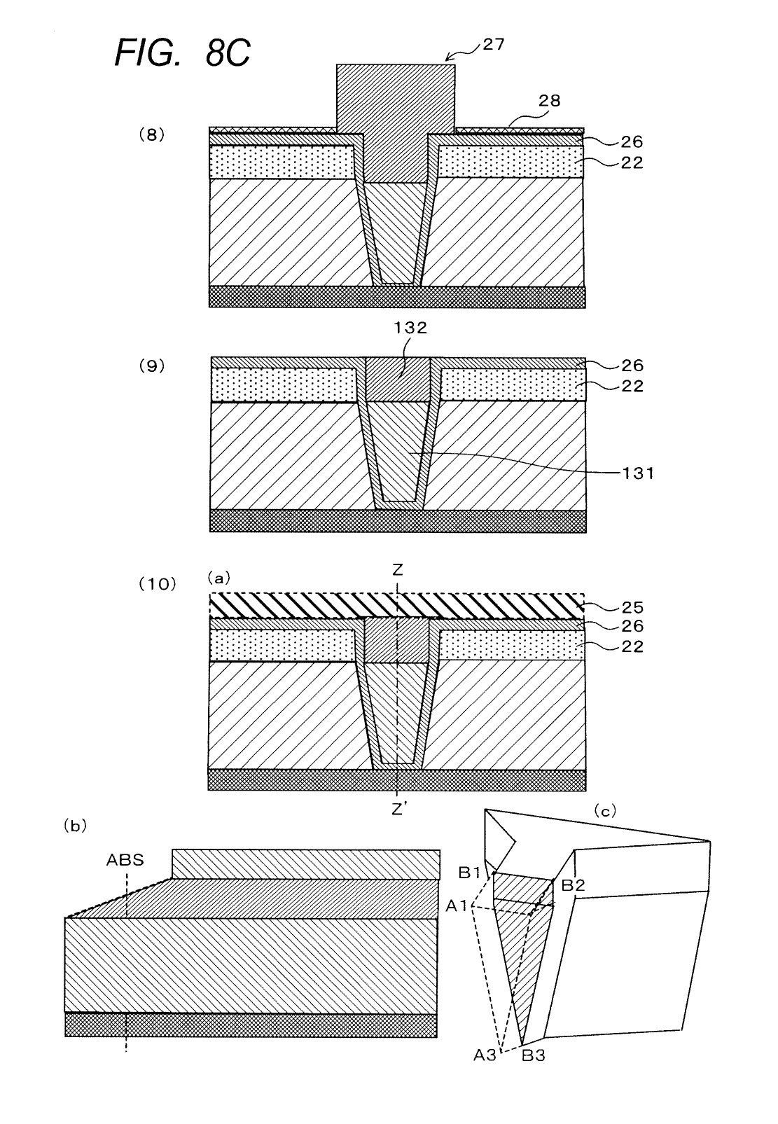

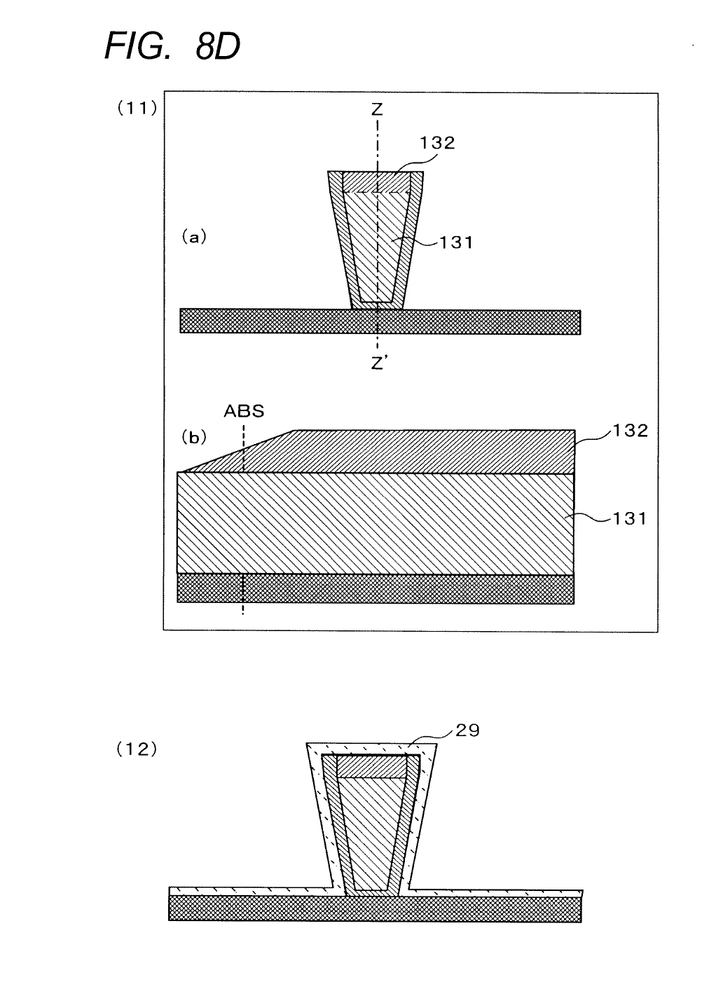

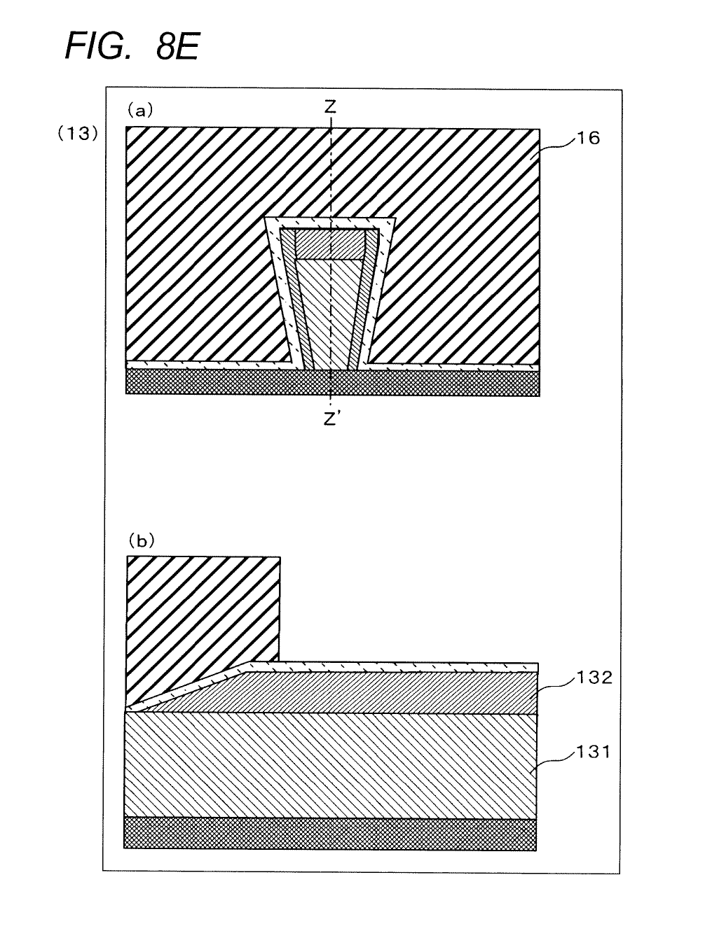

The manufacturing process of the perpendicular recording magnetic head is described with reference to FIGS. 8A to 8E. This example is based on a damascene process in which an alumina trench is formed and then a main pole is filled therein by plating. The following steps 1 to 13 correspond to respective process figures (1) to (13) in FIGS. 8A to 8E.

Step 1: An RIE stopper 24 is first formed on a substrate and then alumina 23 (inorganic insulating film) and a hard mask 22 for forming RIE (Reactive Ion Etching) are formed. These layers are each formed by use of sputtering with good in-plane distribution. In this case, the RIE stopper 24 and the hard mask material use NiCr. Although usually removed, the hard mask 22 is positively left because of being needed to form the second main pole portion in the present invention. This is one feature of the present invention.

Step 2: A photo resist 25 for forming the main pole is next formed on the hard mask 22. In this case, an ArF scanner is used. The thickness of the photo resist 25 is 0.4 μm. The use of the scanner can achieve a flare length adjustment accuracy of ±20 nm or less.

Step 3: The hard mask 22 is subjected to ion milling with the resist 25 used as a mask. In this case, to make the shape of the hard mask vertical, an incident angle is set at 0°. Because of using the ion milling, the track distribution accuracy is within 2%. In this case, the thickness of the hard mask 22 is that of the second main pole portion 132.

Step 4: After the resist 25 has been removed, a V-shaped trench 81 is formed by use of RIE with the hard mask 22 used as a mask. BCL3 is used as gas for the RIE. The desired V-shaped trench can be provided under predetermined etching conditions by use of this gas.

Step 5: A plating seed film 26 is next formed in the V-shaped trench 81 formed in step 4. The plating seed film 26 uses a CNF/NiCr laminated film.

Step 6: A resist 25 for pattern plating is formed (step 6). The use of the pattern plating can enlarge the margin of CMP of a subsequent step.

Step 7: A damascene plating film 27 is next formed (step 7). The damascene plating film 27 uses CoNiFe. The plating composition of CoNiFe plating has a basic bath where CoSO₄, NiSO₄ and FeSO₄ are based, H₃BO₃ and NaCl are added as an additive agent and saccharine sodium is added as a stress reliever. It is preferred that a portion (rectangular portion) 272 defining the track width be greater in the saturation flux density Bs of the plating film than an inverse trapezoidal portion 271. The reason is that the portion 272 defining the track width has the greater saturation flux density Bs; therefore, it is characterized by having a large magnetic field gradient. Because of this, if the same plating bath is used, its plating conditions are such that electric current density during the plating for the rectangular portion 272 is made greater than that for the inverse trapezoidal portion 271. This increases the content of Fe in the plating film, which increases the saturation flux density Bs. Incidentally, it is preferred that the electric current density shift from 10 mA/cm² to 25 mA/cm². However, because of difference due to liquid composition, it is preferred that the electric current density be adjusted in each case. Another method is as below. If the same electric current density is used, two kinds of plating liquids whose Fe concentration in the composition of plating liquid is previously increased are made up for plating.

Step 8: A CMP stopper film 28 is formed on the hard mask 22 on which the plating seed film 26 is formed. DLC (diamond-like carbon) or SiO₂ is effective for the stopper material.

Step 9: The damascene plating film 27 is ground to the upper surface of the plating seed film 26 to remove the stopper material. Since the CMP grinding is finished on the hard mask, the main pole 13 that includes the first main pole portion with a bevel angle and the second main pole portion without a bevel angle can be formed through self-alignment in this step. The formation of the second main pole portion through self-alignment can be included as one of the features of the present invention.

Step 10: A tapered shape is formed by ion milling on the air bearing surface side of the second main pole portion which is the main pole. The resist 25 is formed to be shifted from the air bearing surface, ABS, by a given amount as illustrated in FIG. 8C-(b). Incidentally, FIG. 8C-(b) is a cross-sectional view taken along line Z-Z′ in FIG. 8C-(a). The tapered shape can be formed by use of the ion milling to have a taper angle of 20 to 30° with respect to the air bearing surface. In this case, it is important that when the second main pole portion is taper-etched to the tip portion, i.e., to the air bearing surface, such a tip portion is located within the thickness-range of the second main pole portion. This can stably set the track width even if a deviation in taper angle and a variation during the processing of the air bearing surface occur.

Step 11: Next, NiCr as the material of the hard mask 22 and alumina 23 as the base material of the main pole are solved by wet etching liquid. Incidentally, FIG. 8D-(b) is a cross-sectional view taken along line Z-Z′ in FIG. 8D-(a).

Step 12: Thereafter, alumina 23 for a trailing gap 29 and side gaps is formed. Incidentally, since the main pole has a bevel shape, ALD (atomic layer deposition) is used to form the alumina.

Step 13: Thereafter, a wrap-around shield is formed. In this case, the shield material uses 46 at. % Ni—Fe. The completion of this shield can complete the main portion of the main pole 13. Incidentally, FIG. 8E-(b) is a cross-sectional view taken along line Z-Z′ in FIG. 8E-(a).

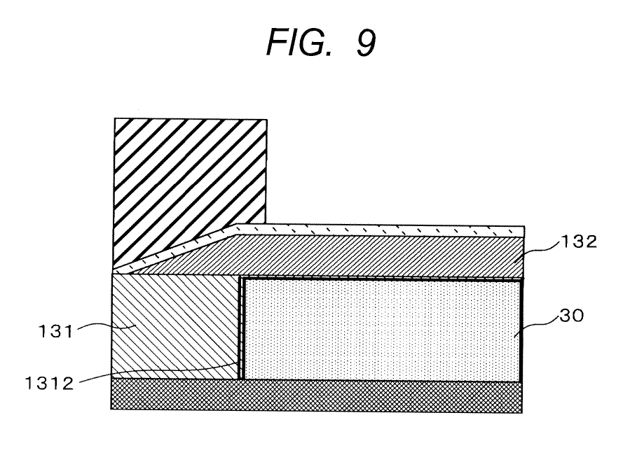

FIG. 9 illustrates a perpendicular recording magnetic head according to another embodiment.

If track width is narrowed to deal with recording density growth, it is necessary to use a material with high magnetic flux density (Bs) for a first main pole portion 131 and a second main pole portion 132 from an air bearing surface to a flare point in order to ensure field intensity. However, if flare height Ly is low, there is concern that the field intensity becomes too high, which degrades field intensity distribution. To eliminate such concern, a material (this portion is denoted by reference numeral 30) having low field intensity is provided to extend from a flare point 1312 in the element-height direction. This can ensure a balance of field intensity as a whole. For example, 80NiFe with a saturation flux density of 1.0 T or 46NiFe with a saturation flux density of 1.6 T can be used as a material with lower saturation flux density (Bs).

The perpendicular recording magnetic heads manufactured as described above are each mounted on the magnetic disk drive. Therefore, it is possible to prevent a reduction in the recording magnetic field due to narrowed track along with improved surface recording density. In addition, the increasing of the accuracy in the track width can be enabled. Thus, the recording performance of the head is enhanced and the yield of the head is improved.

### DESCRIPTION OF THE REFERENCE NUMERALS

1: motor, 2: magnetic disk, 3: suspension arm, 4: slider, 5: rotary actuator, 6: signal processing circuit, 7: perpendicular recording magnetic head, 8: lower read shield, 9: read element, 10: upper read shield, 11: auxiliary pole, 12: thin film coil, 13: main pole, 131: first main pole portion, 132: second main pole portion, 14: read head, 15: write head, 16: wrap-around shield, 17: soft underlayer, 18: magnetic write layer, 19: magnetized pattern, 20: yoke, 21: non-magnetic layer, 22: hard mask, 23: alumina, 24: RIE stopper, 25: resist, 26: plating seed film, 27: main pole plating film, 28: CMP stopper, 29: alumina for top gap formation.

What is claimed is:

1. A perpendicular recording magnetic head comprising:
a main pole;
an auxiliary pole;
a coil generating a magnetic field; and
a shield provided on each of a trailing side and cross track side of the main pole,
wherein the main pole includes a first main pole portion having an inverse trapezoidal shape and a second main pole portion laminated on the first main pole portion, the second main pole portion defining a fixed track width and having a flare portion that is increased in width toward an element-height direction.

2. The perpendicular recording magnetic head according to claim 1,
wherein the second main pole portion has a rectangular air bearing surface and lateral width of the second main pole portion defines the track width.

3. The perpendicular recording magnetic head according to claim 1,
wherein the second main pole portion has a tapered shape extending from a predetermined position of the flare portion to a track tip of the air bearing surface.

4. The perpendicular recording magnetic head according to claim 3,
wherein the track tip portion having the tapered shape is formed within a thickness range of the second main pole portion.

5. The perpendicular recording magnetic head according to claim 1,
wherein saturation flux density (Bs) of the second main pole portion is equal to or greater than that of the first main pole portion.

6. The perpendicular recording magnetic head according to claim 1,
wherein the first main pole portion has a bevel angle but the second main pole portion has no bevel angle.

7. The perpendicular recording magnetic head according to claim 1,
wherein the second main pole portion has the length of width, in a track width direction, equal to the length of width in contact with the trailing side of the first main pole portion.

8. The perpendicular recording magnetic head according to claim 1,
wherein the saturation flux density (Bs) of at least one of the first main pole portion and the second main pole portion is increased toward a flare-height (Ly) zero direction.

9. The perpendicular recording magnetic head according to claim 1,
wherein material of the main pole is a magnetic plating film containing two or three elements of Co, Ni and Fe.

10. A magnetic disk drive writing a signal to a rotating magnetic disk by use of a perpendicular recording magnetic head,
wherein the perpendicular recording magnetic head includes a main pole, an auxiliary pole, a coil generating a magnetic field, and a shield provided on each of a trailing side and cross track side of the main pole, the main pole including a first main pole portion that has an inverse trapezoidal shape and a second main pole portion that is laminated on the first main pole portion and has a rectangular air bearing surface, the second main pole portion defining a fixed track width and having a flare portion that is increased in width toward an element-height direction.

11. A method of manufacturing a perpendicular recording magnetic head that includes a main pole, an auxiliary pole, a coil generating a magnetic field, and a shield provided on each of a trailing side and cross track side of the main pole, the main pole including a first main pole portion that has an inverse trapezoidal shape and a second main pole portion that is laminated on the first main pole portion, the second main pole portion defining a fixed track width and having a flare portion that is increased in width toward an element-height direction, the method comprising the steps of:
forming an inorganic insulating film on a substrate;
forming a hard mask for reactive ion etching (RIE) on the inorganic insulating film;
forming a V-shaped trench by use of RIE with the hard mask used as a mask;
forming a plating seed film on an inner surface of the V-shaped trench; and
forming the first main pole portion and the second main pole portion laminated on the first main pole portion in the V-shaped trench formed with the seed film, by magnetic plating.

12. The method of manufacturing the perpendicular recording magnetic head according to claim 11,
wherein the first main pole portion and the second main pole portion are simultaneously formed through self-alignment.

13. The method of manufacturing the perpendicular recording magnetic head according to claim 12,
wherein when the magnetic plating is performed using the same plating bath, plating current density during the formation of the second main pole portion is made greater than that during the formation of the first main pole portion.

14. The method of manufacturing the perpendicular recording magnetic head according to claim 11,
wherein a tapered shape is formed by ion milling on the air bearing surface side of the second main pole portion and within a thickness range of the second main pole portion.
